(19) United States
(12) Patent Application Publication
(10) Pub. No.: US 2005/0030747 A1
(43) Pub. Date: Feb. 10, 2005

(54) Aromatherapy lamp

(76) Inventor: Stan Bogdal, Portland, OR (US)

Correspondence Address: DELLETT AND WALTERS, P. O. BOX 2786, PORTLAND, OR, 97208-2786, US

(21) Appl. No.: 10/877,064

(22) Filed: Jun. 24, 2004

Related U.S. Application Data
(60) Provisional application No. 60/482,423, filed on Jun. 24, 2003.

(51) Int. Cl. F21V 33/00

(52) U.S. Cl. 362/253

(57) ABSTRACT

An aromatherapy lamp employs a salt crystal with a light and/or heat source therewithin. An aromatherapy substance reservoir is provided in the crystal to generate a pleasing aroma.

### BACKGROUND OF THE INVENTION

This invention relates to lamps and aromatherapy devices.

Aromatherapy makes use of scents to provide a soothing atmosphere. In connection with this, it may be desirable to employ low light conditions, to enhance the experience.

### SUMMARY OF THE INVENTION

In accordance with the invention, a combination lamp and aromatherapy diffuser is provided. The lamp suitably comprises a salt crystal having a light source therewithin. On a portion of the salt crystal, a container is provided to receive the aromatic substance therein.

Accordingly, it is an object of the present invention to provide an improved aromatherapy system and method.

It is a further object of the present invention to provide an improved lamp with aromatherapy features.

It is yet another object of the present invention to provide an improved aromatherapy lamp constructed of a salt crystal.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a side photo of an aromatherapy lamp according to the invention;

FIG. 2 is a top view of the aromatherapy lamp with the aroma substance cup removed;

FIG. 3 is a bottom view of the aromatherapy lamp;

FIG. 4 is a view of the aromatherapy lamp with the components thereof disassembled;

FIG. 5 is a view of an alternate aromatherapy candle; and

FIG. 6 is a sectional view of the salt crystal portion of FIG. 1.

### DETAILED DESCRIPTION

According to a preferred embodiment of the present invention comprises a salt crystal lamp with an aromatherapy substance receiver therein.

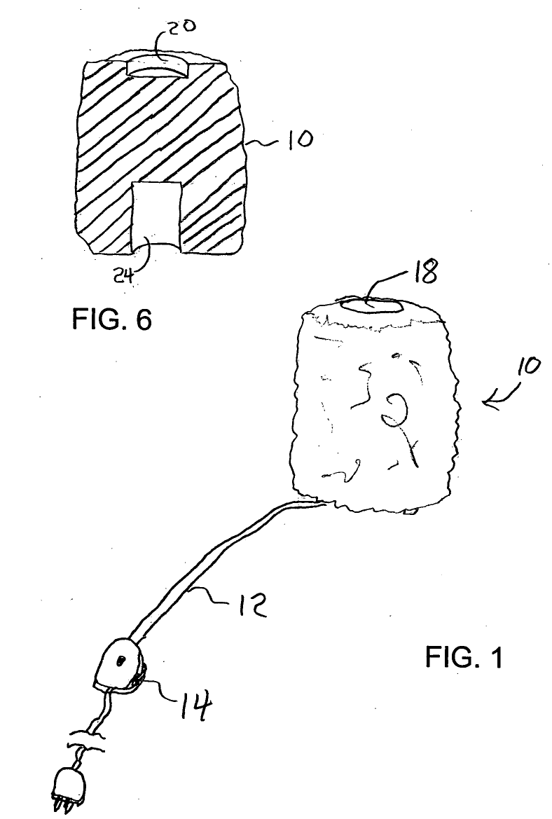

Referring to FIG. 1, a side photo of an aromatherapy lamp, the lamp includes a salt crystal portion 10, which is suitably a rough block shape in the illustrated embodiment. A power cord 12 with on/off switch 14 supplies power to an electric lamp 16 within the interior of the salt crystal. At the top of the salt crystal, an aroma therapy substance holding container 18 is positioned. The aroma therapy substance holding container is suitably a circular glass container in the preferred embodiment, and may be metal with a pleasing color, such as a copper, brass, golden or silver color finish for example.

Referring now to FIG. 2, which is a top view of the aromatherapy lamp with the aroma substance cup removed, it may be observed that the salt crystal has a depression 20 defined therein, suitably having a corresponding shape to that of the exterior of the cup 18, wherein the cup fits into the depression 20 so that it is generally more or less flush or nearly so with the top of the salt crystal.

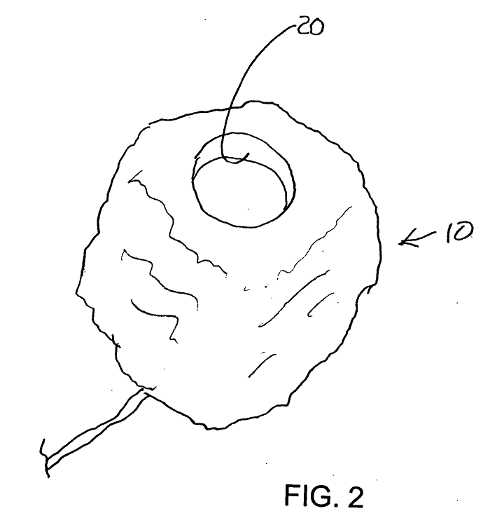

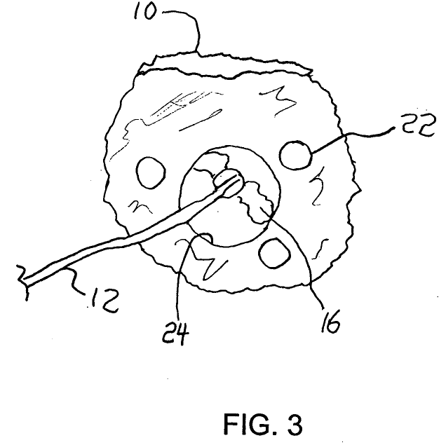

FIG. 3 is a bottom view of the aromatherapy lamp and it may be observed that plural feet 22 are provided on the bottom portion of the salt crystal, to space the lamp slightly above any surface on which it is set, and also to minimize the likelihood of the lamp sliding around on a smooth surface. The salt crystal has a central generally vertical bore 24 defined therein, extending partially into the body of the salt crystal. The bore receives the electric light 16 therewithin.

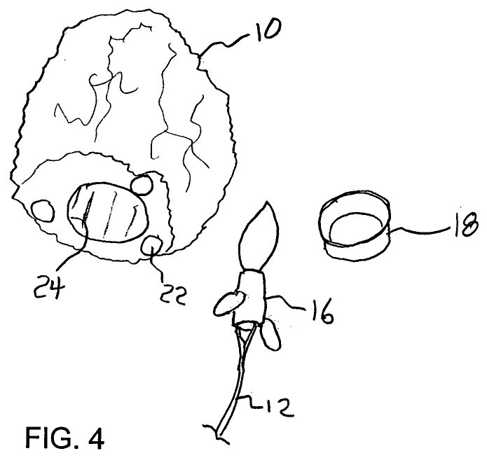

Referring to FIG. 4, a view of the aromatherapy lamp with the components thereof disassembled, it may be observed that the electric lamp includes friction wing members that engage the inner wall of the bore 24, so as to hold the light therewithin, while allowing removal for replacement of the light bulb.

FIG. 6 illustrates the salt crystal portion 10 in sectional view, wherein the section is taken vertically through approximately the center of the crystal.

In use, when the light is illuminated, the salt crystal generates an attractive light glow, which may be an orange color for example, depending on the particular compounds or impurities in the particular salt crystal. The heat from the light bulb will heat the salt crystal, which will heat the aromatherapy cup 18. Thus, any aromatherapy compounds placed within the cup will be heated and caused to release their aroma into the room where the lamp is positioned. The salt crystal also generates negative ions, which are also considered to be helpful.

While the preferred embodiment employs a salt crystal, which is suitably a mined rock salt crystal or halite, other materials are suitable for the lamp base. For example, marble, quartz, or other minerals or rocks. The shape of the crystal can and will vary. The illustrated embodiment is of a salt crystal that is generally elongate and roughly box like, but this is not a requirement or limitation. Any shape, whether square-like, dome-like, pyramidal, globe shaped, or the like may be employed to provide desired aesthetics.

The cup 18 is preferably glass, but may also be metal (e.g., copper), ceramic or porcelain, plastic or other suitable material. The shape of the cup 18 may be altered as desired, with corresponding changes to the cup receiving portion in the salt crystal.

The electric lamp is suitably a 110 volt (in the U.S.) white light small lamp, but can be a low voltage lamp if desired. Other color lamps are employed to enhance or alter the color of the light produced. Battery operated lamps may also be employed. The lamp may be a solid state light source such as a LED (light emitting diode), for example, with a separate heat source to heat the aroma cup 18, if desired.

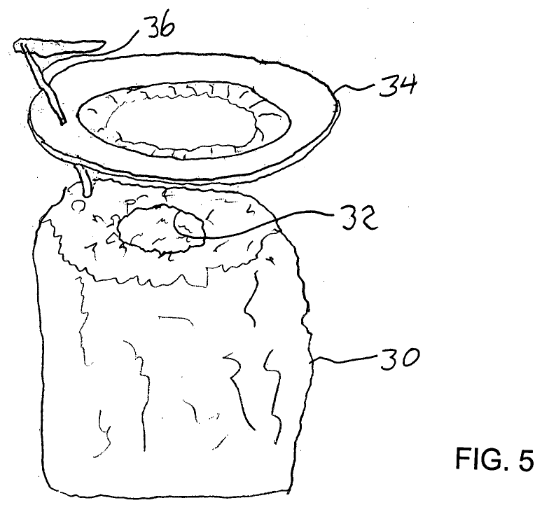

FIG. 5 is an illustration of an alternate form of the lamp. In the FIG. 5 version, a salt crystal is employed with an opening 32 formed therein, in the form of a central vertical bore, for example. The bore may extend the entire extent of the salt crystal, or not. A candle (not visible) may be inserted into the bore to provide light and heat, or an electric light source in the manner of the embodiment of FIGS. 1-4 may be used. Instead of cup 18 inserted into the bore, a cup or plate 34 may be suspended above the opening a certain distance (e.g. an inch or two, as an example) by use of suspension arm 36 which mounts to the salt crystal 30 and the plate 34. Alternatively, the plate may be suspended by a free-standing support that does not rely on the salt crystal for support. An aromatherapy liquid or substance is placed in the plate, and heat from the candle or electric light source in the salt crystal assists in causing the aroma to be dispersed.

Thus, in accordance with the invention, an aromatherapy lamp employing a salt crystal or the like is provided, which gives a pleasing color light off, and generates negative ions. The heat from the lamp provides heat to vaporize the aromatherapy substance.

While plural embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

1. An aromatherapy lamp comprising:
a halite; and
an aromatherapy substance reservoir therein.

2. The aromatherapy lamp according to claim 1, wherein said halite includes a light source therewithin.

3. The aromatherapy lamp according to claim 2, wherein said light source further provides a source of heat for heating said aromatherapy substance reservoir.

4. The aromatherapy lamp according to claim 2, wherein said light source comprises a LED.

5. The aromatherapy lamp according to claim 1, wherein said aromatherapy substance reservoir is suspended a distance away from a face of the halite.

6. An aromatherapy lamp comprising:
a lamp base portion for generating light; and
an aromatherapy substance holding reservoir thereon.

7. The aromatherapy lamp according to claim 6, wherein said lamp base comprises a salt crystal.

8. The aromatherapy lamp according to claim 6, wherein said lamp base comprises marble.

9. The aromatherapy lamp according to claim 6, wherein said lamp base comprises quartz.

10. The aromatherapy lamp according to claim 6, wherein said lamp base generates light via a light source therewithin.

11. The aromatherapy lamp according to claim 6, wherein said light source further provides a source of heat.

12. The aromatherapy lamp according to claim 11, wherein said aromatherapy substance reservoir is heated by the source of heat.

13. The aromatherapy lamp according to claim 10, wherein said light source comprises a LED.

14. A method of providing aromatherapy, comprising the steps of:
providing a lamp base;
placing an aromatherapy substance in relation to said lamp base, whereby heat generated by said lamp base heats the aromatherapy substance.

15. The method of providing aromatherapy according to claim 14, wherein said lamp base comprises a salt crystal.

16. The method of providing aromatherapy according to claim 14, wherein said lamp base comprises quartz.

17. The method of providing aromatherapy according to claim 14, wherein said lamp base comprises marble.

18. The method of providing aromatherapy according to claim 14, wherein said lamp base comprises a halite.

19. The method of providing aromatherapy according to claim 14, wherein said aromatherapy substance is placed in a reservoir held in spaced relation to a face of said lamp base.

20. The method of providing aromatherapy according to claim 14, wherein said aromatherapy substance is placed in a reservoir positioned within a hollowed out portion of said lamp base.
